(19) United States
(12) Patent Application Publication
(10) Pub. No.: US 2018/0085925 A1
(43) Pub. Date: Mar. 29, 2018

(54) FASTENING DEVICE FOR UNITS IN VEHICLE

(71) Applicant: TOBESYSTEM Corp., Incheon (KR)

(72) Inventor: Ki Seong CHOI, Incheon (KR)

(21) Appl. No.: 15/383,681

(22) Filed: Dec. 19, 2016

(30) Foreign Application Priority Data
Sep. 26, 2016 (CN) 201610851436.0

(51) Int. Cl. B25J 9/16; B60N 2/68; B25J 9/12; B25J 9/00; G06K 7/10

(52) U.S. Cl. CPC B25J 9/1687; B60N 2/682; B25J 9/1697; Y10S 901/09; B25J 9/1612; B25J 9/0093; G06K 7/10415; B25J 9/126

(57) ABSTRACT

The present invention relates to a fastening device for a vehicle including: a fastening part adapted to fasten a first unit and a second unit together; a photographing part adapted to photograph fastening positions for fastening the first unit and the second unit together; and a control part adapted to move the fastening part on the basis of the information on the fastening positions photographed by the photographing part. Accordingly, the first unit and the second units of the vehicle seat are accurately fastened together on the basis of the information in which the fastening positions of the vehicle seat are photographed, thereby improving both of the fastening speed and the production speed thereof.

### CROSS REFERENCE TO RELATED APPLICATION(S)

This application claims priority from Chinese Patent Application No. 201610851436.0 filed on Sep. 26, 2016 and all the benefits accruing therefrom under 35 U.S.C. 119, the contents of which in its entirety are herein incorporated by reference.

### BACKGROUND OF THE INVENTION

### Field of the Invention

The present invention relates to a fastening device for units in a vehicle, and more particularly, to a fastening device for units in a vehicle that photographs fastening positions of two units of a vehicle seat, controls a nutrunner performing a fastening operation through the information on the photographed fastening positions, and fastens the two units of the vehicle seat together.

### Background of the Related Art

Generally, a screw fastening operation for fastening the units of vehicle seats produced in a mass production line together is carried out by means of hand tools like drivers or electric tools like electric screws, and so as to achieve productivity improvement, the uniformity in qualities of assembled products and labor cost saving, such screw fastening operation is performed by means of an automatic screw fastener or automated nutrunner that is coupled to an assembly fixed to a jig.

In this case, the nutrunner is a tool that rotates fastening components like bolts or nuts through the rotation of a servo motor and thus conducts a fastening operation. An AC servo nutrunner among kinds of nutrunners does not need to exchange a brush, is easy to control the sequence, and is possible to provide a high precision of torque control. Accordingly, the AC servo nutrunner is widely used in the assembly line of electrical and electric components, the production line of automobiles, the manufacturing and repair of precise machines and the like, and particularly, as the AC servo nutrunner is used much in an automation production line, technological needs for the position control and accurate tightening torque of the nutrunner have to be fully satisfied.

Since fastening positions are different by the gaps and steps existing according to the kinds of vehicle seats, however, it is difficult that the fastening operation is accurately carried out.

Besides, it is impossible that the automated nutrunner adjusts fastening strengths differently according to the kinds of vehicle seats mass-produced from the automation production line.

### SUMMARY OF THE INVENTION

Accordingly, the present invention has been made in view of the above-mentioned problems occurring in the prior art, and it is an object of the present invention to provide a fastening device for units in a vehicle that photographs the fastening positions of a vehicle seat and performs a fastening operation through the control of a nutrunner on the basis of the information on the photographed positions.

It is another object of the present invention to provide a fastening device for units in a vehicle that calculates the gaps and steps existing on the fastening positions of a vehicle seat according to the kinds of vehicle seats, thereby optimizing the accuracy in a fastening operation.

It is yet another object of the present invention to provide a fastening device for units in a vehicle that allows a nutrunner to be moved and controlled to have different fastening strengths according to the calculated results for the gaps and steps existing on the fastening positions of a vehicle seat.

To accomplish the above-mentioned objects, according to the present invention, there is provided a fastening device for a vehicle including: a fastening part adapted to fasten a first unit and a second unit together; a photographing part adapted to photograph fastening positions for fastening the first unit and the second unit together; and a control part adapted to move the fastening part on the basis of the information on the fastening positions photographed by the photographing part.

According to the present invention, desirably, the first unit and the second unit have first holes and second holes fastened together in such a manner as to allow bolts to be passed therethrough in the state where the first holes and the second holes are overlapped with each other, and the fastening part is a nutrunner for fastening nuts fixing the bolts to the first holes and the second holes to the bolts.

According to the present invention, desirably, the nutrunner has an air motor and a servo motor adapted to transmit driving forces thereto through the control part so as to fasten the nuts to the bolts of the first holes and the second holes.

According to the present invention, desirably, the control part calculates at least one of the gaps between the first holes and the second holes and the steps between the first unit and the second unit according to the information on the photographed positions.

According to the present invention, desirably, the fastening device further includes a mounting part adapted to mount the fastening part and the photographing part thereon so that the control part moves the mounting part on the basis of the calculated result to allow the nuts to be fastened to the bolts by means of the nutrunner.

According to the present invention, desirably, the mounting part includes: a mounting stand adapted to mount the fastening part thereon to allow the bolts to be fastened by the fastening part; a vertical shaft disposed on any one surface of the mounting stand and having a moving passage along which the mounting stand is moved in a longitudinal direction thereof; and a horizontal shaft disposed on the underside of the vertical shaft and having a moving passage along which the vertical shaft is moved in a width direction thereof.

According to the present invention, desirably, if the fastening part moves to finish the fastening between the first unit and the second unit, the photographing part photographs the fastened state between the first unit and the second unit, and the control part stores the fastened state and the fastening record in an external server thereof.

According to the present invention, desirably, the first unit and the second unit have the first holes and the second holes fastened together in such a manner as to allow the bolts to be passed therethrough in the state where the first holes and the second holes are overlapped with each other, and a plurality of photographing parts is crossingly arranged to photograph the gaps and steps of the first holes and the second holes to reduce the error range of calculation of the gaps and steps, so that the control part calculates at least one of the plurality of gaps and steps photographed by the photographing parts and stores the photographed states in the external server.

According to the present invention, desirably, the fastening device further includes a tag-reader part adapted to read tag information attached to any one of the first unit and the second unit, and the control part generates the unit information on the first unit and the second unit on the basis of the tag information read from the tag-reader part.

According to the present invention, desirably, the fastening device further includes a communication part adapted to receive the information matching at least one of the information such as reference positions, fastening strengths, the number of rotation times for fastening the bolts, the kinds of fastening components from the external server of the control part in which the matching information is stored, and the control part obtains the matching information on the basis of the generated unit information to control the operations of the fastening part and the photographing part according to the matching information.

According to the present invention, desirably, the control part determines the reference positions as the fastening positions on the basis of the information on the reference positions to move the photographing part, so that the fastening positions are photographed by the photographing part.

According to the present invention, desirably, the fastening device further includes a conveyor belt adapted to move the first unit and the second unit to the fastening positions to allow the fastening part to perform the fastening operation, so that if the fastening is finished by the fastening part, the conveyor belt moves the fastened first unit and second unit to the outside by the control of the control part.

According to the present invention, desirably, the first unit is any one of a seat and a back cushion and the second unit is the other of the seat and the back cushion.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram showing the whole configuration of a fastening device for a vehicle according to a first embodiment of the present invention;

FIG. 2 is a perspective view showing the configuration of the fastening device for a vehicle according to the first embodiment of the present invention;

FIG. 3 is a perspective view showing a vehicle seat according to the first embodiment of the present invention;

FIG. 4 is a rear view showing gaps and steps between a first unit and a second unit in the fastening device according to the first embodiment of the present invention;

FIG. 5 is a perspective view showing the detailed configuration of the fastening part of the fastening device for a vehicle according to the first embodiment of the present invention;

FIG. 6 is a perspective view showing the configuration of the mounting part for a vehicle according to the first embodiment of the present invention;

FIG. 7 is a side view showing an example of the operation of the photographing part of the fastening device for a vehicle according to the first embodiment of the present invention;

FIG. 8 is an exemplary view showing an example of the operation for the gaps and steps in the fastening device for a vehicle according to the first embodiment of the present invention;

FIG. 9 is an exemplary view showing an example of the photographing time points of cameras provided on the display part of the fastening device for a vehicle according to the first embodiment of the present invention;

FIG. 10 is a side view showing the operation of the photographing part of a fastening device for a vehicle according to a second embodiment of the present invention;

FIG. 11 is an exemplary view showing the operation for the gaps and steps in the fastening device for a vehicle according to the second embodiment of the present invention; and

FIG. 12 is an exemplary view showing the photographing time points of cameras provided on the display part of the fastening device for a vehicle according to the second embodiment of the present invention.

### DETAILED DESCRIPTION OF THE PREFERRED EMBODIMENT

Hereinafter, an explanation on a fastening device for a vehicle according to the present invention will be in detail given with reference to the attached drawing. Before the present invention is disclosed and described, it is to be understood that the disclosed embodiments are merely exemplary of the invention, which can be embodied in various forms. So as to clearly explain the present invention, a portion having no relation to the explanation is omitted in the drawing, and the widths, lengths and thicknesses of the components shown in the drawing may be magnified for the clarity and convenience of the description. The present invention is disclosed with reference to the attached drawings wherein the corresponding parts in the embodiments of the present invention are indicated by corresponding reference numerals.

The present invention relates to a fastening device for units in a vehicle, and more particularly, to a fastening device for units in a vehicle that photographs fastening positions of two units of a vehicle seat, controls a nutrunner performing a fastening operation through the information on the photographed fastening positions, and fastens the two units of the vehicle seat together.

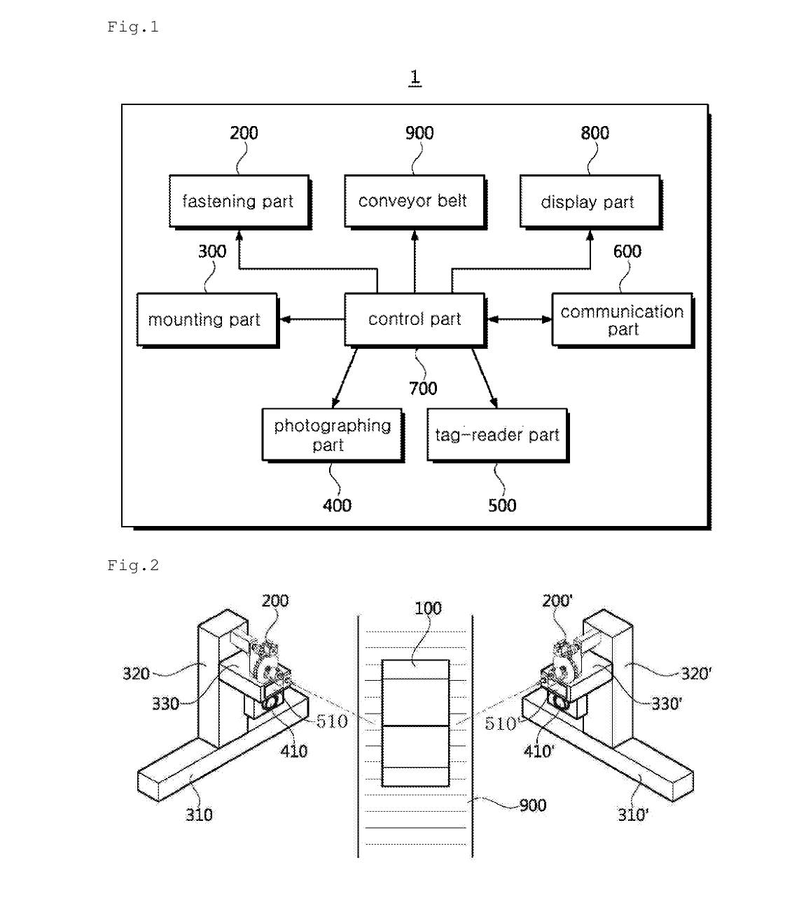

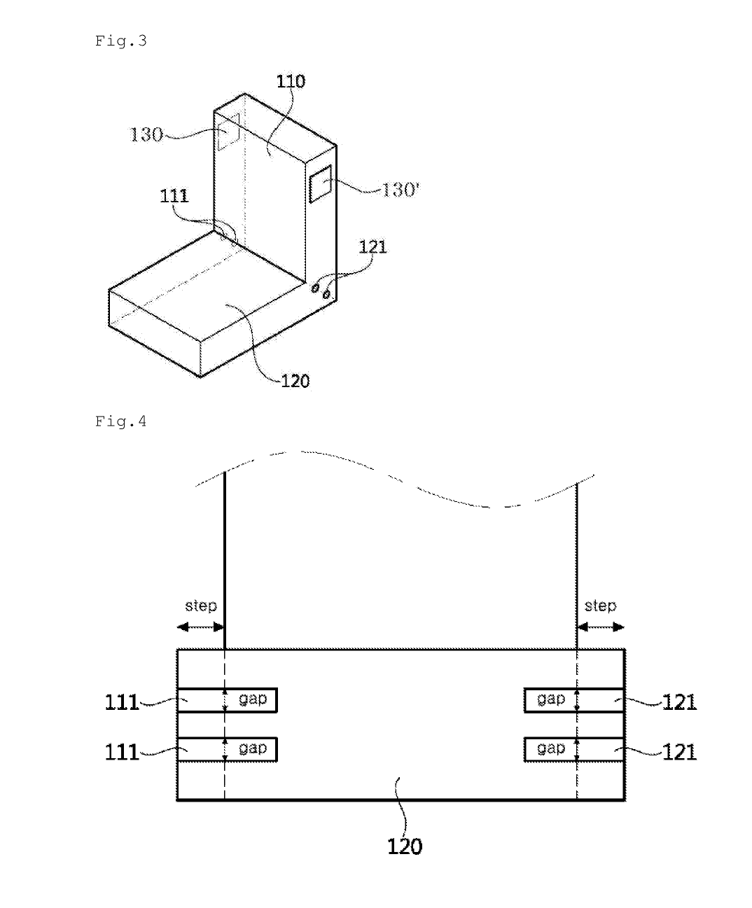

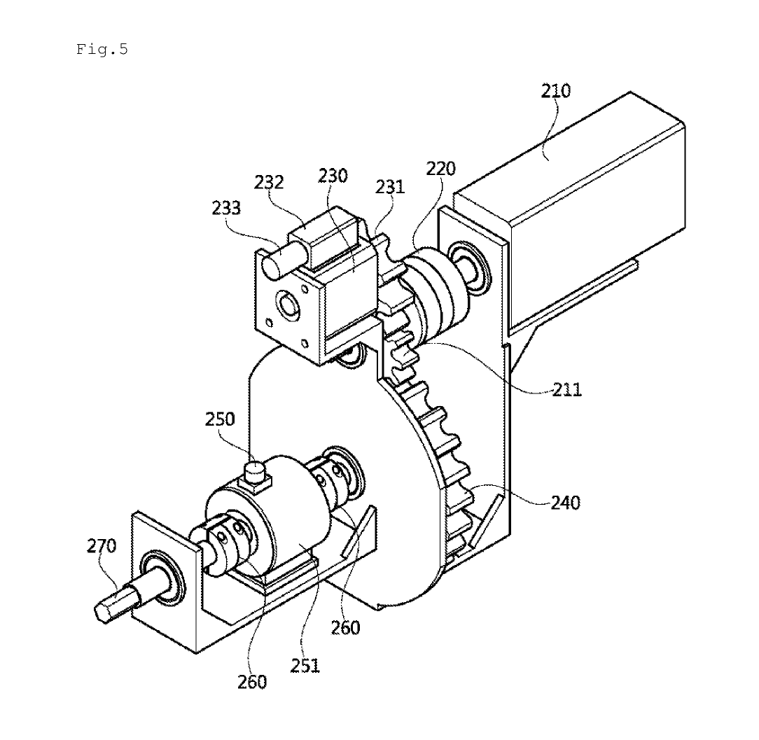

FIG. 1 is a block diagram showing the whole configuration of a fastening device for a vehicle according to a first embodiment of the present invention, FIG. 2 is a perspective view showing the configuration of the fastening device for a vehicle according to the first embodiment of the present invention, FIG. 3 is a perspective view showing a vehicle seat according to the first embodiment of the present invention, and FIG. 4 is a rear view showing gaps and steps between a first unit and a second unit in the fastening device according to the first embodiment of the present invention.

As shown in FIGS. 1 to 4, a fastening device for units in a vehicle according to the present invention, which is adapted to fasten the units constituting a vehicle seat 100, includes a fastening part 200, a mounting part 300, a photographing part 400, a tag-reader part 500, a communication part 600, a control part 700, a display part 800, and a conveyor belt 900.

The vehicle seat 100 is provided to allow a vehicle user to sit therein and includes a first unit 110 and a second unit 120.

The first unit 110 is a back cushion for supporting the back region of a user of the vehicle seat 100 and has first holes 111 formed on portions of both sides thereof to insert bolts thereinto, so that the first unit 110 is fastened to the second unit 120.

The second unit 120 is a seat in which the user of the vehicle seat 100 sits and has second holes 121 formed on portions of both sides thereof to insert bolts thereinto, so that the second unit 120 is fastened to the first unit 110.

Further, the first holes 111 and the second holes 121 are formed in such a manner as to allow the bolts to be passed through the spaces overlappedly formed on the portions of both sides of the first unit 110 and the second unit 120, so that the first unit 110 and the second unit 120 are fastened together by means of the fastening part 200.

Furthermore, gaps and steps are formed on the first unit 110 and the second unit 120 having the first holes 111 and the second holes 121 fastened together. According to the present invention, the gaps become the inner peripheries of the first holes 111 and the second holes 121 through which the bolts are passed, and the steps are the protruding degrees of one of the first unit 110 and the second unit 120 from the other unit when the first unit 110 and the second unit 120 are fastened together.

Moreover, the vehicle seat 100 has RFID (Radio Frequency Identification) tags 130 and 130′ disposed on portions of both sides of at least one of the first unit 110 and the second unit 120, and the tag-reader part 500 receives the unit information from the RFID tags 130 and 130′.

Further, the unit information stored in advance in RFID tags 130 and 130′ is different from the kinds of vehicles.

The fastening part 200 is adapted to fasten the first unit 110 and the second unit 120 together and is a nutrunner for fastening nuts fixing the bolts to prevent the bolts passed through the first holes 111 and the second holes 121 from being escaped from the first holes 111 and the second holes 121. The fastening part 200 fastens the bolts under the control of the control part 700.

The configuration of the fastening part 200 for fastening the first unit 110 and the second unit 120 together according to the present invention will be in detail explained later with reference to FIG. 5.

The mounting part 300 is adapted to move the fastening part 200 in such a manner as to allow the bolts passed through the first holes 111 and the second holes 121 overlapped with each other to be fastened and includes a horizontal shaft 310, a vertical shaft 320 and a mounting stand 330.

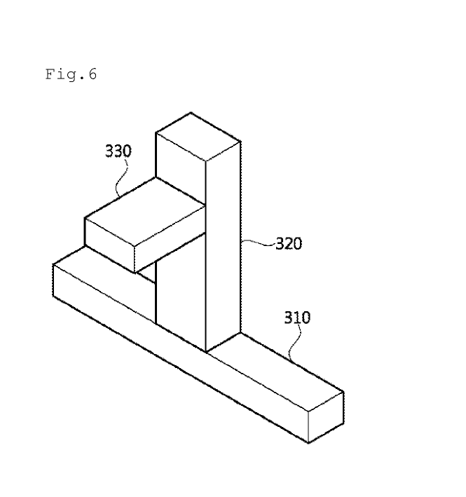

The configuration of the mounting part 300 for moving the fastening part 200 to the positions of the first holes 111 and the second holes 121 according to the present invention will be in detail explained later with reference to FIG. 6.

The photographing part 400 is disposed on a portion of the mounting part 300 to photograph the fastened state between the first unit 110 and the second unit 120 by means of the fastening part 200 and includes a camera 410.

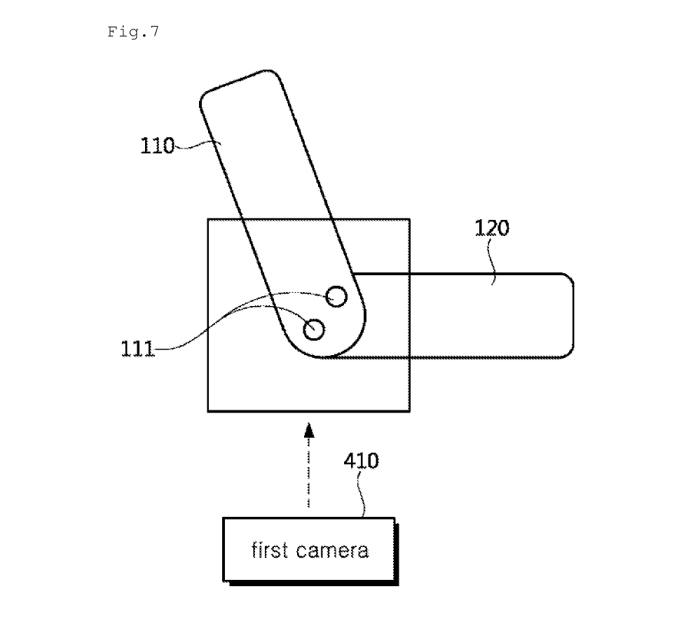

The method for checking the fastened state between the first unit 110 and the second unit 120 through the camera 410 according to the present invention will be in detail explained later with reference to FIG. 7.

The tag-reader part 500 is adapted to read the unit information from the RFID tags 130 and 130′ disposed on at least one of the first unit 110 and the second unit 120 and includes an RFID reader 510.

The RFID reader 510 is adapted to read the tag information of the RFID tags 130 and 130′ disposed on at least one of the first unit 110 and the second unit 120, and thus, one pair of RFID readers 510 and 510′ is disposed on portions of one pair of mounting parts 300 and 300′.

As a result, the RFID readers 510 and 510′ transmit the tag information read from the RFID tags 130 and 130′ to the control part 700, and the control part 700 generates the unit information on the basis of the tag information of the first unit 110 and the second unit 120.

According to the present invention, even though the unit information is read using RFID, a sensor tag or radio frequency identification tag using radio frequency, in which the unit information of the first unit 110 and the second unit 120 is stored and read, may be of course used.

The communication part 600 is adapted to allow the operations of the fastening part 200, the mounting part 300 and the photographing part 400 for fastening the first unit 110 and the second unit 120 together to be controlled through the control part 700.

If the control part 700 generates the unit information from the tag information read from the RFID tags 130 and 130′ of the vehicle seat 100 through the RFID readers 510 and 510′ of the tag-reader part 500, further, the communication part 600 receives the information matching by unit information from an external server disposed on the control part 700.

In more detail, the communication part 600 receives the information matching at least one of the information such as the fastening positions of the first holes 111 and the second holes 121, the fastening strengths of the nutrunner for fastening the bolts passed through the first holes 111 and the second holes 121 overlapped with each other, the number of rotation times of the nutrunner for fastening the bolts, the kinds of nuts as fastening components according to the sizes of the outer peripheral surfaces of the bolts passed through the first holes 111 and the second holes 121, from the external server of the control part 700 in which the matching information is stored in advance.

The communication part 600 transmits the information matching by unit information to the control part 700, and accordingly, the control part 700 controls the operations of the fastening part 200, the mounting part 300 and the photographing part 400 on the basis of the matching information received.

The control part 700 is connected to the external server so as to control the whole operation of the fastening device for a vehicle according to the present invention.

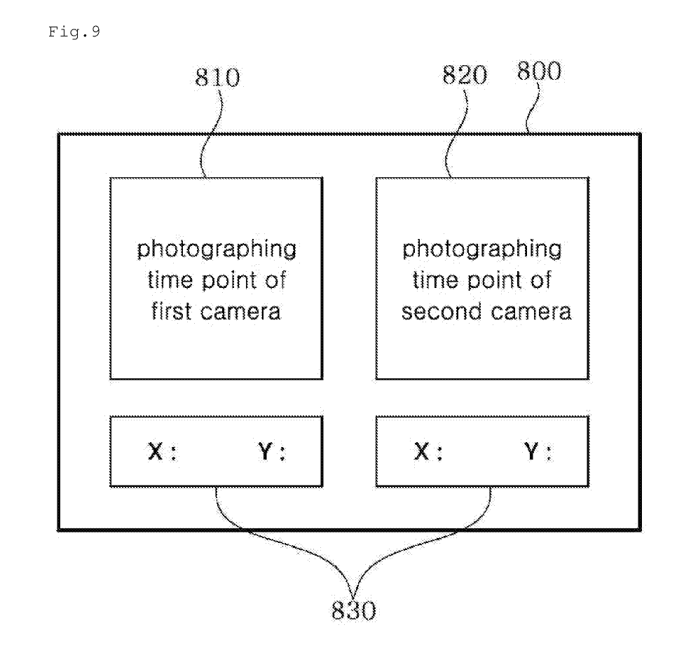

A control method of the control part 700 according to the present invention will be in detail explained later with reference to FIGS. 7 and 9.

The display part 800 is adapted to check the whole operation of the fastening device according to the present invention by means of the control part 700 and outputs a first fastening coordinate image 810, a second fastening coordinate image 820, and a coordinate operation image 830.

An output method of the display part 800 according to the present invention will be in detail explained later with reference to FIGS. 7 and 9.

The conveyor belt 900 is adapted to move the first unit 110 and the second unit 120 of the vehicle seat 100 to the fastening positions and is controlled by the control part 700 to move the vehicle seat 100 to a predetermined position.

After the fastening between the first unit 110 and the second unit 120 of the vehicle seat 100 is finished, if it is checked that the fastening between the first unit 110 and the second unit 120 of the vehicle seat 100 is finished through the external server connected to the control part 700, the conveyor belt 900 moves the vehicle seat 100 to the outside by the control of the control part 700.

So as to fasten the first unit 110 and the second unit 120 of the vehicle seat 100 together, conclusively, the photographing part 400 photographs the fastening positions to calculate the gaps and steps existing on the fastening positions, and the unit information is read by means of the tag-reader part 500. Next, the communication part 600 receives the unit information stored in advance from the external server of the control part 700 to receive the unit information matching the tag information read from the tag-reader part 500, and accordingly, the fastening operation is accurately performed irrespective of the kind of the vehicle seat 100.

If the communication part 600 transmits the matching unit information to the control part 700, the control part 700 moves the fastening part 200, the mounting part 300 and the photographing part 400 to the fastening positions on the basis of the matching information, thereby optimizing the accuracy in the fastening operation for the vehicle seat 100.

FIG. 5 is a perspective view showing the detailed configuration of the fastening part of the fastening device for a vehicle according to the first embodiment of the present invention.

As shown in FIG. 5, the fastening part 200 is adapted to fasten the first unit 110 and the second unit 120 of the vehicle seat 100 together and includes a servo motor 210, a latch handle 220, an air motor 230, a driven gear 240, a connector 250, couplings 260, and a hexagonal wrench 270.

According to the present invention, the fastening part 200 is adapted to fasten the bolts passed through the first holes 111 and the second holes 121 and is the nutrunner for fastening the nuts to prevent the bolts from being escaped from the first holes 111 and the second holes 121.

The servo motor 210 generates rotary power to fasten the nuts to the bolts with the hexagonal wrench 270 and transmits the rotary power to a first driving gear 211.

The latch handle 220 is adapted to allow the servo motor 210 to generate the rotary power in one direction and is disposed between the servo motor 210 and the first driving gear 211 to transmit the rotary power only in one direction, thereby preventing the reverse rotation.

The air motor 230 is adapted to increase the rotational speed of the fastening part 200 and includes a second driving gear 231, an air valve 232 and an air tube passage 233.

The second driving gear 231 transmits a driving force to the fastening part 200, and if compressed air is introduced into the air motor 230 through the air tube passage 233, the second driving gear 231 is driven by the air motor 230 to transmit the driving force to the hexagonal wrench 270 of the fastening part 200.

The air valve 232 is adapted to introduce the compressed air into the air motor 230 through the air tube passage 233 and is open and closed by means of the control part 700 to control the introduction of the compressed air.

The air tube passage 233 serves as a passage used to introduce the compressed air into the air motor 230 by means of the air valve 232.

If the air motor 230 is driven, the second driving gear 231 rotates at a high speed, and the transmission of the rotary power to the servo motor 210 is prevented. As high torque of the servo motor 210 is needed in a high torque area, the latch handle 220 is disposed between the servo motor 210 and the first driving gear 211, so that the rotary power can be transmitted in one direction.

The driven gear 240 is adapted to transmit the rotary power to the hexagonal wrench 270 and serves as a speed reducer provided to have a given gear ratio with respect to the first driving gear 211 to reduce the rotational speed of the servo motor 210, thereby increasing the torque.

The connector 250 is adapted to allow the fastening part 200 to be controlled by means of the control part 700, and if the connector 250 is connected to the external server of the control part 700, at least one of the information such as the fastening strengths, the number of fastening rotation times, the kinds of fastening components when the bolts passed through the first holes 111 and the second holes 121 are fastened by means of the fastening part 200 is measured through a measuring sensor 251 and then transmitted to the control part 700.

The couplings 260 are adapted to fix the measuring sensor 251 thereto and are disposed on both sides of the measuring sensor 251.

The hexagonal wrench 270 is adapted to fasten the nuts for preventing the escape of the bolts to the bolts passed through the first holes 111 and the second holes 121, while rotating with the rotary power generated from the servo motor 210 and the air motor 230.

FIG. 6 is a perspective view showing the configuration of the mounting part for a vehicle according to the first embodiment of the present invention.

As shown in FIG. 6, the mounting part 300 is adapted to move the fastening part 200 to the fastening positions of the vehicle seat 100 and includes the horizontal shaft 310, the vertical shaft 320 and the mounting stand 330.

The mounting stand 330 is adapted to mount the fastening part 200 thereon and protrudes from one end of the vertical shaft 320 in a width direction of the mounting part 300.

The vertical shaft 320 is adapted to move the mounting stand 330 in a longitudinal direction thereof and has a moving passage formed on one end on which the mounting stand 330 is disposed in a longitudinal direction thereof.

The horizontal shaft 330 is adapted to move the vertical shaft 320 in the width direction thereof and has a moving passage formed on the underside of the vertical shaft 320 in the width direction thereof.

If the communication part 600 receives the unit information having the tag information read from the first unit 110 and the second unit 120 from the tag-reader part 500, which matches the unit information stored in advance in the external server of the control part 700, the mounting part 300 is controlled and moved to the fastening positions between the first unit 110 and the second unit 120 under the control of the control part 700.

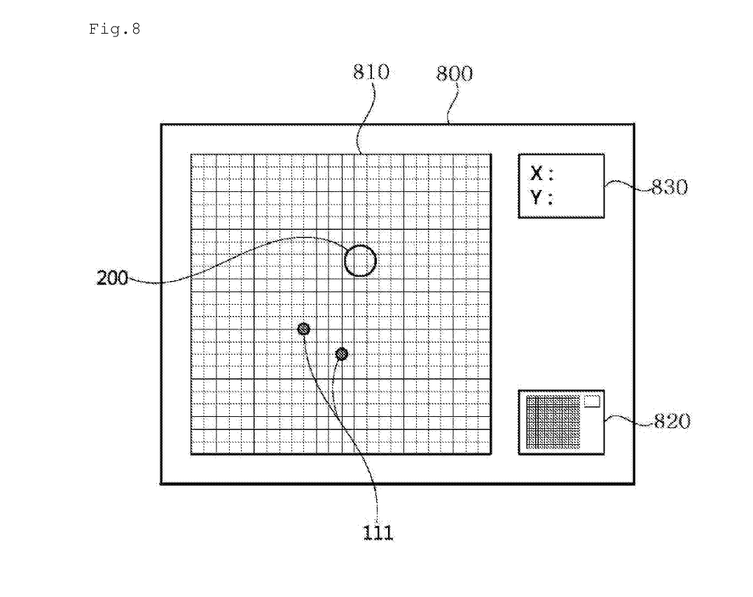

FIG. 7 is a side view showing an example of the operation of the photographing part of the fastening device for a vehicle according to the first embodiment of the present invention, FIG. 8 is an exemplary view showing an example of the operation for the gaps and steps in the fastening device for a vehicle according to the first embodiment of the present invention, and FIG. 9 is an exemplary view showing an example of the photographing time points of cameras provided on the display part of the fastening device for a vehicle according to the first embodiment of the present invention.

As shown in FIGS. 7 to 9, the photographing part 400 is adapted to check the fastening positions between the first holes 111 and the second holes 121 and at the same time to calculate the gaps and steps to achieve an accurate fastening operation and includes the camera 410, and the control part 700 is connected to the external server.

The camera 410 photographs the fastening positions between the first holes 111 and the second holes 121, and since the first holes 111 and the second holes 121 are formed on the portions of both sides of the vehicle seat 100, a first camera 410 and a second camera 410′ are disposed on portions of one pair of mounting parts 300 and 300′.

The first camera 410 and the second camera 410′ are controlled by means of the control part 700 so that their photographing areas are moved to the fastening positions different according to the kind of the vehicle seat 100.

The first camera 410 checks whether the first unit 110 and the second unit 120 are fastened together through the photographing areas for the first holes 111, and the second camera 410′ checks whether the first unit 110 and the second unit 120 are fastened together through the photographing areas for the second holes 121. Further, the first camera 410 and the second camera 410′ photograph the fastened states to calculate at least one of the gaps and steps in the process where the first holes 111 and the second holes 121 are overlapped with each other and transmit the photographed fastened states to the control part 700.

The control part 700 is connected to the display part 800 so as to control the movements of the fastening part 200 and the mounting part 300 on the basis of the information on the fastening positions displayed on the photographing areas of the photographing part 400.

The display part 800 outputs the first fastening coordinate image 810, the second fastening coordinate image 820, and the coordinate operation image 830 so that the fastening positions displayed on the photographing areas of the photographing part 400 can be checked by a manager.

The first fastening coordinate image 810 is used to indicate the position of the fastening part 200 for fastening the first holes 111, and in this case, the first holes 111 and the fastening part 200 positioned in the photographing area of the first camera 410 are indicated on the first fastening coordinate image 810. The first fastening coordinate image 810 calculates a distance difference of the fastening part 200 from the fastening positions of the first holes 111 through the control part 700 and outputs the calculated result to the coordinate operation image 830.

The second fastening coordinate image 820 is used to indicate the position of the fastening part 200′ for fastening the second holes 121, and in this case, the second holes 121 and the fastening part 200′ positioned in the photographing area of the second camera 410′ are indicated on the second fastening coordinate image 820. The second fastening coordinate image 820 calculates a distance difference of the fastening part 200′ from the fastening positions of the second holes 121 through the control part 700 and outputs the calculated result to the coordinate operation image 830.

So as to calculate the distance differences by means of the first fastening coordinate image 810 and the second fastening coordinate image 820, the first holes 111, the second holes 121 and the fastening parts 200 and 200′ are outputted as values of x, y and z coordinates.

The coordinate operation image 830 outputs the distance differences between the first holes 111 and the fastening part 200 and between the second holes 121 and the fastening part 200′ indicated on the first fastening coordinate image 810 and the second fastening coordinate image 820, as the x, y or z coordinates with respect to the fastening positions of the first holes 111 and the second holes 121.

Further, at least one of the first fastening coordinate image 810 and the second fastening coordinate image 820 is outputted as a main image to the display part 800, and the calculated values of the gaps and steps existing on the fastening positions of the vehicle seat 100 outputted from the main image are controlled by means of the control part 700, so that the calculated image (not shown) outputted to the display part 800 is checked by the manager.

So as to check the first fastening coordinate image 810 and the second fastening coordinate image 820 at the same time, the first fastening coordinate image 810 and the second fastening coordinate image 820 are displayed at the same time on the display part 800, and the coordinate operation image 830 is outputted and displayed at the same time together with the respective fastening coordinate images.

If the fastening operations of the fastening parts 200 and 200′ are finished through the first fastening coordinate image 810 and the second fastening coordinate image 820, the fastening record is automatically stored in the external server of the control part 700.

Accordingly, the fastening part 200 receives the rotary power from the servo motor 210 and the air motor 230, and the mounting part 300 moves the fastening part 200 to the fastening positions, so that the fastening operation is carried out.

Further, the fastening positions of the first holes 111 and the second holes 121 are photographed by means of the pair of first and second cameras 410 and 410′ of the photographing part 400, and the images of the photographing areas of the photographing part 400 are outputted to the display part 800 connected to the control part 700. The distance differences between the first holes 111 and the fastening part 200 and between the second holes 121 and the fastening part 200′ with respect to the fastening positions of the first holes 111 and the second holes 121 are calculated and outputted as the x, y or z coordinates to the display part 800 by means of the control part 700.

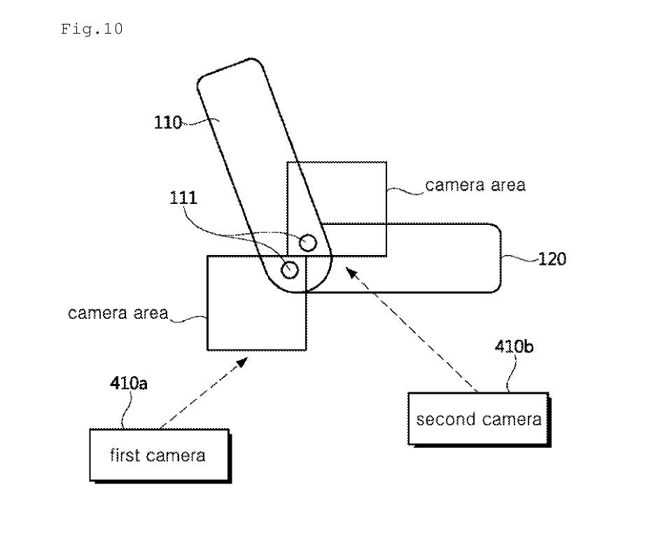

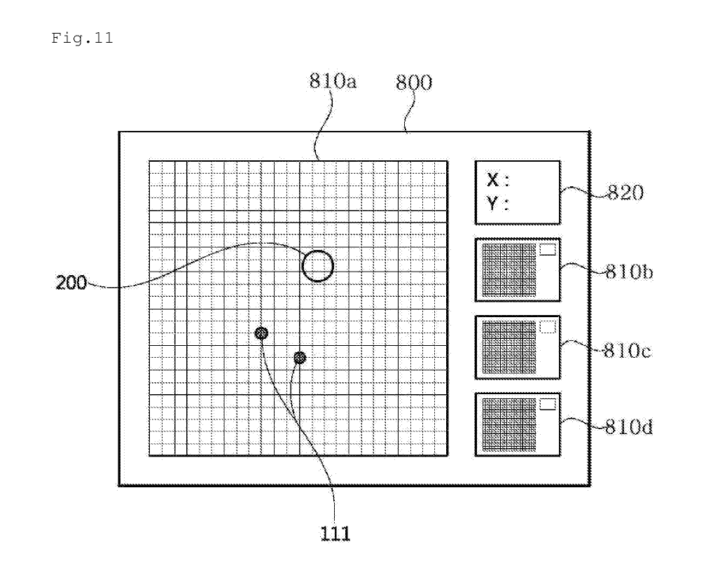

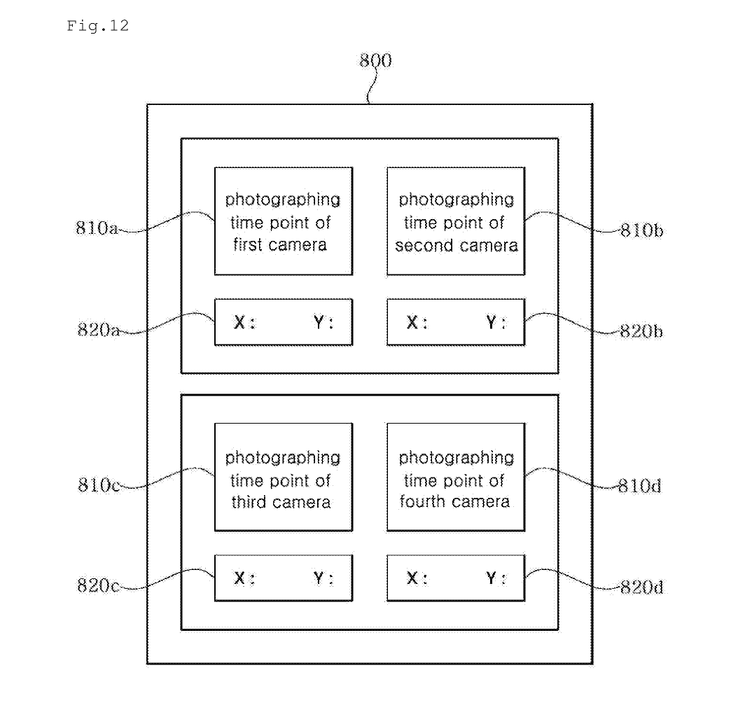

FIG. 10 is a side view showing the operation of the photographing part of a fastening device for a vehicle according to a second embodiment of the present invention, FIG. 11 is an exemplary view showing the operation for the gaps and steps in the fastening device for a vehicle according to the second embodiment of the present invention, and FIG. 12 is an exemplary view showing the photographing time points of cameras provided on the display part of the fastening device for a vehicle according to the second embodiment of the present invention.

According to the second embodiment of the present invention, as shown in FIGS. 10 to 12, a photographing part 400 is adapted to check the fastening positions between the first holes 111 and the second holes 121 and at the same time to calculate the gaps and steps to achieve an accurate fastening operation and includes a plurality of first to fourth cameras 410a to 410d, and the control part 700 is connected to the external server.

The photographing part 400 has the plurality of first to fourth cameras 410a to 410d so as to reduce the error range of the gaps and steps existing on the fastening positions of the first holes 111 and the second holes 121.

The first to fourth cameras 410a to 410d are disposed crossingly on the portions of the mounting parts 300 and 300′ in such a manner as to have different photographing areas from each other to photograph the fastening positions at various angles under the control of the control part 700, so that they transmit the gaps and steps existing on the fastening positions of the first holes 111 and the second holes 121 so and at the same time reduce the error range of the calculation in the control part 700.

The first to fourth cameras 410a to 410d are disposed crossingly on the portions of the mounting parts 300 and 300′ in such a manner as to allow their photographing areas to be not overlapped or partially overlapped with each other. In this case, they are not located in front of the fastening positions, but are differently located on the mounting parts 300 and 300′ at given angles.

The control part 700 is connected to the display part 800 so as to control the movements of the fastening part 200 and the mounting part 300 on the basis of the information on the fastening positions displayed on the photographing areas of the photographing part 400.

The display part 800 outputs a fastening coordinate image 810 and a coordinate operation image 820 to allow the fastening positions displayed on the photographing areas of the photographing part 400 to be checked by a manager.

The fastening coordinate image 810 is used to indicate the fastening positions of at least one of the first holes 111 and the second holes 121 and the position of the fastening part 200 performing the fastening operation, so that the plurality of photographing areas of the photographing part 400 corresponding to the number of cameras 410a to 410d is outputted to allow the gaps and steps on the fastening positions at which the fastening operations are performed by the fastening parts 200 and 200′ to be checked at the various angles.

According to the present invention, the first to fourth cameras 410a to 410d are connected to first to fourth fastening coordinate images 810a to 810d of the fastening coordinate image 810 through the control part 700, so that the fastening positions of at least one of the first holes 111 and the second holes 121 and the positions of the fastening parts 200 and 200′ are outputted to the display part 800.

If the fastening positions of at least one of the first holes 111 and the second holes 121 and the positions of the fastening parts 200 and 200′ are displayed on the fastening coordinate image 810, the gaps and steps of the fastening positions are calculated by means of the control part 700, and at the same time, a distance difference between the fastening positions and the fastening part 200 is calculated by means of the control part 700, so that the positions of the first holes 111, the second holes 121 and the fastening parts 200 and 200′ are outputted as x, y or z coordinates.

Further, the fastening coordinate image 810 calculates the distance differences between the fastening positions of at least one of the first holes 111 and the second holes 121 and the fastening part 200 with the x, y or z coordinates by means of the control part 700, and the calculated values are outputted to the coordinate operation image 830.

Further, at least one of the first to fourth fastening coordinate images 810a to 810d is outputted as a main image to the display part 800, and the calculated values of the gaps and steps existing on the fastening positions outputted from the main image are controlled by means of the control part 700, so that the calculated image (not shown) outputted to the display part 800 is checked by the manager.

So as to check the first to fourth fastening coordinate images 810a to 810d at the same time, the first to fourth fastening coordinate images 810a to 810d are displayed at the same time on the display part 800, and accordingly, a plurality of coordinate operation images 830 corresponding to the number of first to fourth fastening coordinate images 810a to 810d is outputted and displayed at the same time together with the first to fourth fastening coordinate images 810a to 810d.

The fastening coordinate images 810, which calculate the distance difference between the photographed areas of the first holes 111 and the fastening part 200 by means of the control part 700 and is outputted to the display part 800, is displayed on the display part 800 dividedly from the fastening coordinate images 810 which calculate the distance difference between the photographed areas of the second holes 111 and the fastening part 200 by means of the control part 700 and is outputted to the display part 800, so that they are checked by the manager.

Accordingly, when the gaps and steps existing on the fastening positions of the first holes 111 and the second holes 121 are calculated by means of the control part 700, the first to fourth cameras 410a to 410d of the photographing part 400 are provided crossingly in such a manner as to allow their photographing areas to be not overlapped or partially overlapped with each other, so that the accuracy in the calculated result of the control part 700 can be optimized.

Further, the plurality of fastening coordinate images 810a to 810d outputting the distance differences between the fastening positions of the first holes 111 and the second holes 121 and the fastening part 200 is outputted to the display part 800 in such a manner as to correspond to the number of cameras 410a to 410d, so that the accuracy in the fastening operation can be optimized.

As described above, accordingly, the first unit and the second units of the vehicle seat are accurately fastened together on the basis of the information in which the fastening positions of the vehicle seat are photographed, thereby improving both of the fastening speed and the production speed thereof.

Further, if the gaps and steps existing on the fastening positions are calculated according to the kinds of vehicle seats, the nutrunner moves to the fastening positions in such a manner as to be controlled to have different fastening strengths on the basis of the calculated results, so that the fastening operation can be accurately carried out irrespective of the kinds of vehicle seats.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A fastening device for a vehicle, comprising:
a fastening part adapted to fasten a first unit and a second unit together;
a photographing part adapted to photograph fastening positions for fastening the first unit and the second unit together;
a control part adapted to move the fastening part on the basis of the information on the fastening positions photographed by the photographing part; and
a tag-reader part adapted to read tag information attached to any one of the first unit and the second unit,
wherein if the fastening part moves to finish the fastening between the first unit and the second unit, the photographing part photographs the fastened state between the first unit and the second unit, and the control part stores the fastened state and the fastening record in an external server thereof; the first unit and the second unit have first holes and second holes fastened together in such a manner as to allow bolts to be passed therethrough in the state where the first holes and the second holes are overlapped with each other; if the photographing part is provided plurally, the plurality of photographing parts is arranged crossingly to photograph at different angles from each other the fastened states including gaps between the first holes and the second holes and steps between the first unit and the second unit, and the control part calculates at least one of the gaps and steps photographed by the plurality of photographing parts and stores the photographed fastened states in the external server thereof; and the fastening device further comprises: a communication part adapted to produce unit information on the first unit and the second unit on the basis of the tag information read by the tag-reader part and to receive the information matching at least one of the information such as reference positions, fastening strengths, the number of rotation times for fastening the bolts, the kinds of fastening components from the external server of the control part in which the matching information is stored, wherein the control part obtains the matching information on the basis of the produced unit information to control the operations of the fastening part and the photographing part according to the matching information and moves the photographing part to the fastening positions determined as the reference positions on the basis of the reference positions to allow the fastening positions to be photographed; and a display part adapted to compensate for the information on the reference positions on the basis of the information on the photographed positions thus to compensate for the coordinates to be moved by the fastening part and to display the information on the photographed positions thereon, wherein if the photographing part is provided plurally, the display part outputs a plurality of fastening coordinate images at the same time on the basis of the individually photographed fastened states by the plurality of photographing parts, the plurality of fastening coordinate images indicating the fastening positions of at least one of the first holes and the second holes and the position of the fastening part photographed at different angles, and if the photographing part is provided plurally, the control part controls the operations of the photographing parts on the basis of the matching information and calculates at least one of the gaps and steps photographed at the different angles on the basis of the plurality of fastening coordinate images.

2. The fastening device according to claim 1, wherein the first unit and the second unit have the first holes and the second holes fastened together in such a manner as to allow the bolts to be passed therethrough in the state where the first holes and the second holes are overlapped with each other, and the fastening part is a nutrunner for fastening nuts fixing the bolts to the first holes and the second holes to the bolts.

3. The fastening device according to claim 2, wherein the nutrunner has an air motor and a servo motor adapted to transmit driving forces thereto through the control part so as to fasten the nuts to the bolts of the first holes and the second holes.

4. The fastening device according to claim 2, wherein the control part calculates at least one of the gaps between the first holes and the second holes and the steps between the first unit and the second unit according to the information on the photographed positions.

5. The fastening device according to claim 4, further comprising a mounting part adapted to mount the fastening part and the photographing part thereon so that the control part moves the mounting part on the basis of the calculated result to allow the nuts to be fastened to the bolts by means of the nutrunner.

6. The fastening device according to claim 5, wherein the mounting part comprises:
a mounting stand adapted to mount the fastening part thereon to allow the bolts to be fastened by the fastening part;
a vertical shaft disposed on any one surface of the mounting stand and having a moving passage along which the mounting stand is moved in a longitudinal direction thereof; and
a horizontal shaft disposed on the underside of the vertical shaft and having a moving passage along which the vertical shaft is moved in a width direction thereof.

7. The fastening device according to claim 1, further comprising a conveyor belt adapted to move the first unit and the second unit to the fastening positions to allow the fastening part to perform the fastening operation, so that if the fastening is finished by the fastening part, the conveyor belt moves the fastened first unit and second unit to the outside by the control of the control part.

8. The fastening device according to claim 1, wherein the first unit is any one of a seat and a back cushion and the second unit is the other of the seat and the back cushion.
